(19) United States
(12) Patent Application Publication
(10) Pub. No.: US 2022/0097521 A1
(43) Pub. Date: Mar. 31, 2022

(54) HYDRODYNAMIC AUTOMATIC TRANSMISSION

(71) Applicant: Mikhail Magomedovich Omarov, selo Novo-Georgievka, Dagestan (RU)

(72) Inventor: Mikhail Magomedovich Omarov, selo Novo-Georgievka, Dagestan (RU)

(21) Appl. No.: 17/310,120

(22) PCT Filed: Aug. 6, 2019
(86) PCT No.: PCT/RU2019/000554

§ 371 Date: Jul. 16, 2021

(30) Foreign Application Priority Data
Jan. 17, 2019 (RU) 2019101257

(51) Int. Cl. B60K 31/12; F16D 33/08; F16H 41/26; F16H 47/07

(52) U.S. Cl. CPC B60K 31/12; F16H 47/07; F16H 41/26; F16D 33/08

(57) ABSTRACT

The invention relates to a hydrodynamic transmission gear-box that contains two pump wheels, which are round flat disks, on the front peripheral part of which installed firmly are radially directed blades. The first wheel is rigidly connected to the input shaft. The second and subsequent pump wheels, each with a diameter greater than the previous one, are mounted with their own hubs onto the hubs of the preceding pump wheels with the possibility of free rotation on them. On the back side of each disk, a device is installed to block it with the next pump wheel, and the last pump wheel—with the turbine wheel. The turbine wheel is mounted on the input shaft and in the crankcase of the drive device on bearings and is connected to vehicle's reverse mechanism and running gear. Reduction in weight and size, increase of service life and performance improvement are achieved.

### CROSS-REFERENCE TO RELATED APPLICATION

This application is a U.S. national phase application of International Application No. PCT/RU2019/000554, which claims the benefit of Russia Application No. 2019101257, filed Jan. 17, 2019, each of which is hereby incorporated herein by reference in its entirety.

### TECHNICAL FIELD

The invention relates to the field of transport engineering and concerns the design of elements of a step gear-box used in automatic transmissions of vehicles.

Nowadays, there are automatic and hydro-mechanical gear-boxes in which the transmission is carried out by means of gears (RU 2341384, RU 2585093, RU 2659163, RU 2 481511). The disadvantages of gear-boxes mentioned above are their heavy weight and size, complexity of design, which contains a large number of gears and switching mechanisms, complexity of maintenance and repair. In addition, inclusion of a hydrodynamic torque converter in the design of existent automatic transmissions leads to an additional increase in the weight and size characteristics of vehicle drive.

Also known is a hydrodynamic torque converter for transmission RU 2294469, which consists of a housing, connected with a pump wheel and drive shaft of a driving unit; a turbine wheel is connected with the drive shaft of the gear-box; the reactor is mounted between the pump wheel and the turbine wheel; a torsional vibration damper; a friction-driven clutch that connects the housing and the turbine wheel; a freewheel connecting the reactor with the pump shaft that is rigidly connected to gear-box housing, distinctive in that the drum of the friction-driven clutch is welded to the inner surface of the housing; the drum is of a stepped form, while on the inner surface of the larger diameter of the drum facing the turbine made are slots for installation of friction discs, and onto the inner surface of the smaller diameter of the drum facing the housing formed is a flat surface to support the piston; on the axis of rotation of the housing made outwards is a circular recess, outside of which made is a technological girdle for centering the hydrodynamic torque converter when installing it; pressed into the inner part of the circular recess is an anchor sleeve for the gear-box drive shaft, which has an internal axial hole, inserted into which is a slide bearing; made in the sidewalls of the anchor sleeve of the drive shaft are channels to feed oil into the cavity formed between the housing and the piston of the friction-driven clutch; the anchor sleeve is made step-like, on the outer surface of which slots are made to connect with the piston of the friction-driven clutch and the groove installed in which is an o-ring; at the same time, the turbine wheel is connected by fastening elements with a drive sleeve for transmission input shaft and a disk, in which at least one torsional vibration damper is installed and on the outer surface of which made are slots for installation of friction discs of the friction-driven clutch; the drive sleeve has an axial through hole with slots; the drive sleeve is separated by thrust bearings from the anchor sleeve—on the one side, and from the freewheel sleeve—on the other side, and along the outer diameter of the housing welded are at least three elements for mounting to the drive unit.

The disadvantage of such a hydrodynamic converter is the complexity of its design, and the presence of a large number of parts with limited service life. In addition, to change the output shaft torque, it is necessary to use also manual or automatic transmission gear-box connected to such converter.

### SUMMARY

An object of the invention and an achievable technical result is the simplification of the design of vehicle's automatic transmission gear-box by eliminating its mechanical part with a large number of gears and complex gear-transmission mechanisms, and by simplifying the design of the blocking device of the hydrodynamic torque converter, which allows to reduce weight and size, increase maintainability, service life and improve performance properties of the vehicle's automatic transmission gear-box.

The obtained technical result is achieved due to the fact that proposed is a hydrodynamic transmission gear-box comprising of at least two pump wheels, which are round flat discs, on the front peripheral part of which firmly mounted are radially directed blades, with the first wheel being rigidly connected with the input shaft, the second and subsequent pump wheels, the diameter of each of which is larger than the diameter of the preceding one, have their hubs mounted onto the hubs of the preceding pump wheels with the possibility of free rotation on them, but without the possibility of mutual axial movement, so that installed on the back side of each disk is a device to block it with the next pump wheel, and the last pump wheel—with turbine wheel; mounted on the front side of the second and subsequent pump wheels and on the turbine wheel are cylindrical rings with internal cogs for coupling with the locking devices mounted on the back side of pump wheels; the blades of the turbine wheel from the side facing the blades of the pump wheels are covered by a cone-shaped ring disc, the larger diameter of which is equal to the diameter of the disc of the last pump wheel, while the smaller diameter equals the smaller diameter of the blades of the first pump wheel, with the turbine wheel being mounted on the input shaft and in the housing of the drive unit on bearings and is connected with the vehicle's reverse mechanism and running gear. The device for locking the pump wheels includes a toothed segment with guides, stock with a groove, arms and a stopper, a sleeve with a cup and arms located on the stock, while in the cup there is a spring backed by the stock arms, eccentrics connected on one side to the pump wheel, and on the other side to the arms of the sleeve with the cup, a servomechanism including springs connected to the pump wheel on one side and to the stock arms on the other side, a thrust washer fixed to the pump wheel and a spring that bears against the stock limiter, while the guides of the toothed segment are so made as to allow the radial movement of the toothed segment along the axis of the stock, while restricting the movement of the toothed segment in the tangential direction.

### BRIEF DESCRIPTION OF THE DRAWINGS

Embodiments of the proposed invention is explained by drawings:

FIG. 1 is a general front and partially cross-sectional view of an embodiment of a hydrodynamic automatic transmission gear-box,

FIG. 2 is a front and partially cross-sectional view of an embodiment of a device for blocking and unblocking pump wheels in an unblocked position,

FIG. 3 is a front and partially cross-sectional view of an embodiment of the device for blocking and unblocking pump wheels in a blocked position.

In the Figures:
a-a—axis passing through the points of hinge attachment of the ends of servomechanism springs on the stock arms; and
b-b—axis passing through the points of hinge attachment of servomechanism springs on the internal pump wheel.

### DETAILED DESCRIPTION

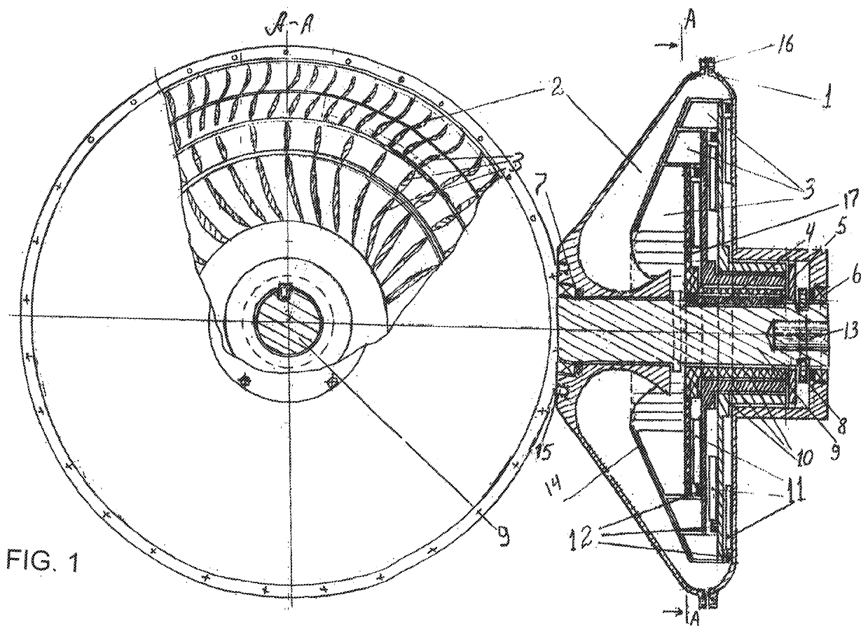

How an embodiment of the hydrodynamic automatic transmission works is described below with reference to FIGS. 1-3.

With reference to FIG. 1, when the input shaft 9 rotates, the first pump wheel 17, rigidly connected to the input shaft 9, creates a flow of working fluid, which fills the internal cavity of the gear-box. The velocity of the working fluid flow has radial and tangential components. On the hub 10 of the first pump wheel (internal) 21, a second (external) pump wheel 22 is mounted with the possibility of free rotation on it. The flow of the working fluid falling on the blades 3 of the external pump wheel 22 sets it in motion. Similarly driven are subsequent pump wheels (there can be any number of them), who also rotate freely on the hubs 10 of the preceding pump wheels. In this case, a cone-shaped ring disk 14 directs the working fluid flow accelerated by the pump wheels 22 to the peripheral part of a turbine wheel 1. The flow of the working fluid, reaching the blades 3 of the turbine wheel 1, which is rigidly connected to the housing and the output shaft 9 through holes 15, transmits to them the torque from the input shaft 9. To hermetically seal the gear-box and to prevent leakage of the working fluid, oil and tightening seals may be used.

At the start of low-speed rotation of the input shaft 9 (vehicle's neutral gear), no torque is transmitted to the turbine wheel 1 because the value of the flow rate and internal sliding of the working fluid is insignificant. When the number of revolutions of the input shaft 9 increases and the flow rate of the working fluid increases in the radial and tangential directions, the turbine wheel 1 receives torque first only from the first pump wheel 17 (vehicle's first gear). In this case, the second and subsequent pump wheels, rotating freely on the hubs of preceding pump wheels, do not create resistance to the transference of the working fluid flow in the radial and tangential directions.

With further increase in the number of revolutions of input shaft 9 and first pump wheel 17 rigidly connected to it, when a certain number of revolutions is reached, with the help of pump wheel blocking device 11, the first pump wheel 17 is blocked with the second pump wheel (second gear of movement), then jointly rotating first and second pump wheels with the subsequent one (third gear) and so on. And upon reaching a certain number of revolutions of the jointly rotating pump wheels 17, the last pump wheel is blocked with turbine wheel (housing) 1.

When the vehicle's speed decreases due to changes in external conditions, and the number of revolutions of the turbine wheel 1 decreases to a certain value, the housing of the turbine wheel 1 is unblocked from the last pump wheel. With a further decrease in the speed of rotation of the turbine wheel 1 caused by a further decrease in the vehicle's speed, the speed of rotation of the last of the pump wheels decreases, and when their rotation speed decreases to a certain value, a sequential unblocking of the next pump wheel 17 from the other blocked wheels occurs. Thus, when a certain number of revolutions is reached, a reverse gear shift occurs.

The number of revolutions at which the pump wheels 21, 22 lock and unlock is set for the locking mechanism of each pump wheel 17. In FIG. 1, reference numeral 34 refers to a key, reference numeral 5 refers to a washer, reference numeral 6 refers to a bearing, reference numeral 7 refers to an oil seal, reference numeral 8 refers to a locking ring, reference numeral 12 refers to cylindrical rings with internal teeth, reference numeral 13 refers to internal slots of the drive shaft, reference numeral 16 refers to lugs for connecting halves of the housing of the turbine wheel 1; and reference numeral 17 refers to the first pump wheel.

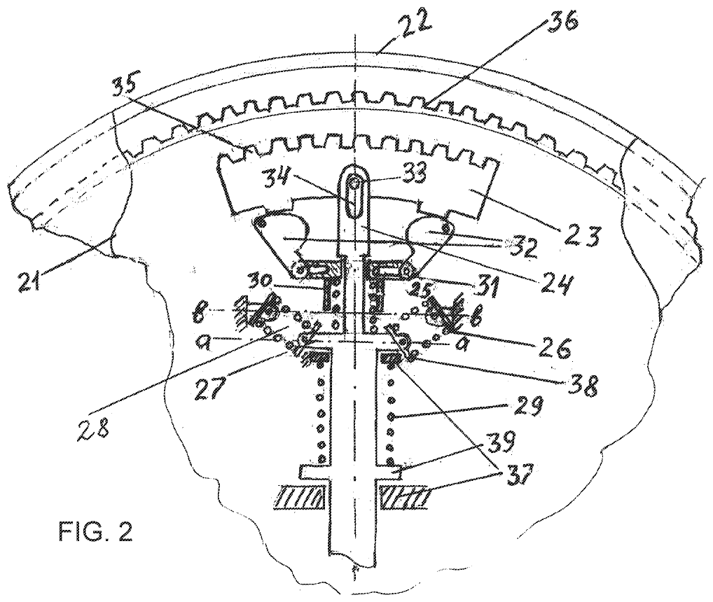

The blocking and unblocking of the pump wheels 21, 22 is described below with reference to FIGS. 2 and 2.

When the internal pump wheel 21 rotates, under the action of centrifugal force, the teethed segment 23 and stock 24 start moving radially from the center to the periphery, overcoming the counteraction of springs 25, 26 and 29, and blocking the blocking of the pump wheels 21 and 22. Moreover, with an increase in the number of revolutions and increase in the centrifugal force, the counteracting force from servomechanism 28 with springs 26 will decrease due to a change in the angle of application of forces, and when axes a-a and b-b coincide, the counteracting force will become zero. The moment axis a-a passes axis b-b, a sharp movement of the stock arms 27 to the periphery will occur, since the force of the springs 26 of the servomechanism 28 will also be added to the centrifugal force, which will also be directed to the periphery. The stock arms 27 will abut the cup 30 of the sleeve with arms 31, overcoming the resistance of weak spring 25, and the whole system will connect the teeth 35 of the teethed segment 23 of the inner wheel 21 with the teethed ring edge 36 of the outer pump wheel 22. The sleeve with arms 31 will close the rear side of the toothed segment 23 with the cams of the eccentrics 32, which will ensure a reliable engagement of the two disks. With that, the pin 33 will end up at the lower (nearer to the center of the disk) edge of the groove or slot 34.

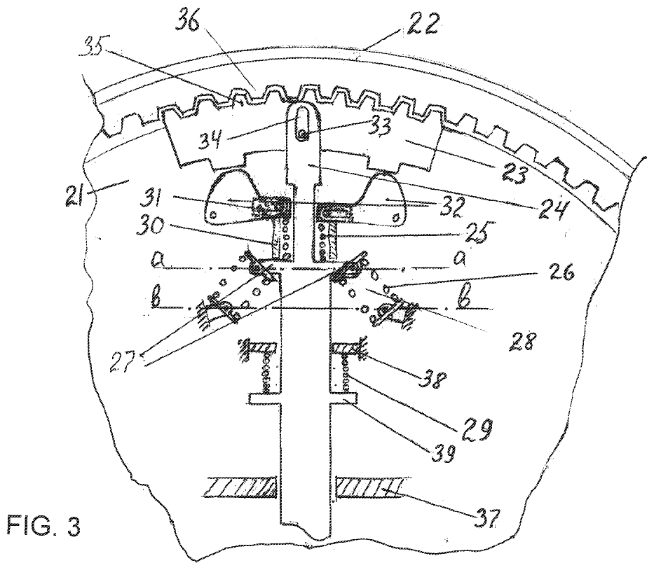

When the speed of joint rotation of the blocked pump wheels 21 and 22 is reduced to a certain limit, the stock 24 and the toothed gear segment 23, under the action of spring 25, overcoming the counteraction of the servomechanism 28, begin to move radially from the periphery to the center of the pump wheels 21, 22 (unblocking them). After axis a-a crosses the line of axis b-b, the resistance of the servo-mechanism 28 stops, and under the action of the springs 26 and 29, there will be a sharp movement of the stock 24 to the center of the pump wheels 21, 22, and the sleeve with arms 31 will unlock via eccentric 32 the toothed segment 23, which will be released from engagement and the pump wheels 21 and 22 will rotate separately. In FIGS. 2 and 3, reference numeral 37 refers to a guide sleeve, reference numeral 38 refers to a thrust washer, and reference numeral 39 refers to a stock limiter.

Thus, the proposed design provides simultaneous performance of functions of the torque converter and automatic transmission gear-box, which allows to exclude complex gear transmission mechanisms from the design, the simple design of the locking device also includes a small number of interconnected parts, which leads to simplification of design, increased reliability, maintainability and reduction in weight and size of gear-box as a whole.

1. A hydrodynamic transmission gear-box for a vehicle, comprising:
at least two pump wheels, which are round flat discs, on a front peripheral part of which firmly mounted are radially directed blades,
wherein a first wheel is rigidly connected with an input shaft;
wherein a second wheel and subsequent pump wheels, a diameter of each of the subsequent pump wheels is larger than a diameter of a preceding one of the subsequent pump wheels, have hubs that are mounted onto the hubs of preceding pump wheels and are permitted to freely rotate thereon, but are restricted from mutual axial movement,
wherein a device is installed on a back of each of the round flat discs to block each of the round flat discs with a corresponding one of the subsequent pump wheels, and a last of the pump wheels with a turbine wheel;
wherein a front side of the second wheel and the subsequent pump wheels and a front side of the turbine wheel include cylindrical rings with internal teeth for coupling with the locking device;
wherein blades of the turbine wheel from a side that faces blades of the pump wheels are covered with a cone-shaped ring disc,
wherein a larger diameter of the cone-shaped ring disc is equal to a diameter of the round flat disc of the last pump wheel, and a smaller diameter of the cone-shaped ring disc equals a smaller diameter of blades of a first one of the pump wheels; and
wherein the turbine wheel is mounted on the input shaft within a crankcase of a drive device on bearings and is connected to a reverse mechanism and drive gear of the vehicle.
